(19) United States
(12) Patent Application Publication
(10) Pub. No.: US 2004/0001108 A1
(43) Pub. Date: Jan. 1, 2004

(54) Calendar control

(75) Inventors: Randall A. Craig, Raleigh, NC (US); Bethany L. Kessen, Austin, TX (US); Alex D. Little, Raleigh, NC (US); Angela P. Robertson, Apex, NC (US)

Correspondence Address: IBM Corporation T81/503, PO Box 12195, Research Triangle Park, NC, 27709, US

(73) Assignee: International Business Machines Corporation, Armonk, NY (US)

(21) Appl. No.: 10/180,266

(22) Filed: Jun. 26, 2002

(51) Int. Cl. G09G 5/00

(52) U.S. Cl. 345/839; 345/817

(57) ABSTRACT

A calendar control. The calendar control can include a multiplicity of graphically toggleable calendar dates. Each toggleable calendar date can have one of either a selected state or a de-selected state. Importantly, unlike prior art calendar displays, each toggleable calendar date can assume one of the selected and de-selected states with consideration to the states of contiguous ones of the calendar dates. An application programming interface further can be provided through which external application programs can access the calendar date states.

### BACKGROUND OF THE INVENTION

1. Statement of the Technical Field

The present invention relates to the field of graphical user interface (GUI) controls, and more particularly to a calendar control.

2. Description of the Related Art

The conventional graphical user interface (GUI) has been widely used for many years. The primary function of the GUI includes providing visual controls with which the end-user can interact with an underlying application. The common GUI includes many stock visual controls, most of which, when combined, can accommodate most computer-human interactions required by an application. For example, the static text box control can be used to present text to the end-user while an edit box can permit the user to provide textual input to the application. A radio button control can provide for the exclusive selection of an element from among a field of elements, while a checklist box can control can provide for the non-exclusive selection of elements from among a field of elements.

In many graphical applications, oftentimes it is necessary for the end user to select one or more calendar dates as parameters to the graphical application. For example, in an air travel reservation application, it will be necessary for the end-user to select a departure date and return date. Similarly, in a calendaring application, often it can be helpful to select a range of dates such as a series of contiguous dates during which the end-user will be on vacation. In most cases, however, it will be necessary for the end user to specify a set of non-contiguous dates such as those dates when the end-user must perform a task, or those dates when the end-user will attend a meeting. Still, the known set of conventional GUI stock components does not include a graphical component able to support the specification of a set of non-contiguous dates.

For example, as described in U.S. Pat. No. 6,323,883 B1 to Tadaaki Minoura et al., scheduling applications can provide a graphical display of a calendar in which a range of contiguous dates can be visually indicated. Yet, as will be apparent from the Minoura specification, the calendar display apparatus is an integral part of the scheduling application and cannot be extricated therefrom. Thus, unlike conventional GUI controls which can be re-used across graphical applications, the calendaring apparatus of Minoura can interact only with the corresponding scheduling application. In any case, as Minoura relates strictly to the display of a calendar rather than the computation of a set of calendar dates, Minoura does not account for the problem at hand—the selection of a set of non-contiguous dates within a GUI control component.

Like Minoura, U.S. Pat. No. 6,064,975 to Billy G. Moon et al. relates to the display of a calendar interface in a handheld graphical application. In particular, as disclosed in the Moon specification, individual, non-contiguous holiday dates can be displayed differentially relative to non-holiday dates within a day planning application. Still, like Minoura, in the Moon dates merely are displayed differentially in a non-contiguous manner. Moreover, like Minoura the calendar display is included as an integral part of the day planning application and cannot be extricated therefrom. Finally, the Moon specification wholly lacks any teaching directed toward the selection and production of a set of calendar days.

Unlike the Minoura and Moon inventions, in each of U.S. Pat. No. 5,570,109 to Scott A. Jenson, and in U.S. Pat. No. 6,236,396 B1 to Scott A. Jenson et al., a selection method for selecting a set of calendar dates is disclosed. In particular, the Jenson patents teach the selection of contiguously positioned date ranges in a handheld device. More particularly, in one aspect of the Jenson invention, a range of dates can be selected by dragging a stylus across a range of dates displayed in the handheld touchscreen. In another aspect of the Jenson invention, a range of dates can be selected by drawing a box about a selection of contiguously positioned dates displayed in the handheld device.

Still, in both exclusive aspects of the Jenson invention, the calendar dates must be contiguously positioned in order to form the basis of a calendar date selection set. Thus, the Jenson technology cannot be applied to the more general problem of easily selecting a set of dates, regardless of the position of the dates as displayed in the GUI. In addition, inasmuch as the Jenson invention relates exclusively to handheld technologies, the Jenson invention fails to account for the typical calendar date selection issues faced by users of calendaring applications in personal computing devices. Finally, like Minoura and Moon, as the Jenson calendar interface is exclusively included as part of the underlying calendar application, the Jenson calendar interface cannot be applied generically to other computing applications as in the case of conventional GUI controls.

### SUMMARY OF THE INVENTION

The present invention is calendar control which overcomes the limitations and deficiencies of prior art graphical calender displays. In particular, the calendar control of the present invention can include a multiplicity of graphically toggleable calendar dates. Each toggleable calendar date can have one of either a selected state or a de-selected state. Importantly, unlike prior art calendar displays, each toggleable calendar date can assume one of the selected and de-selected states with consideration to the states of contiguous ones of the calendar dates. An application programming interface further can be provided through which external application programs can access the calendar date states.

In one aspect of the invention, the graphically toggleable calendar dates can be arranged in a graphical display of a single calendar month. In another aspect of the invention, however, the graphically toggleable calendar dates can be arranged in a graphical display of a range of months. In the alternative case, a multi-month display control can be included which, upon activation, can arrange the graphically toggleable calendar dates in a graphical display of a range of months.

A method of resolving a set of calendar dates can include displaying a multiplicity of toggleable calendar dates in a graphical calendar display responsive to receiving an activating signal from an independent application program. Selected ones of the calendar dates can be visually toggled within the graphical calendar display between a selected state and a de-selected state without regard to the state of contiguous ones of the calendar dates. All of the calendar dates having a selected state can be identified. Subsequently, the identified calendar dates can be forwarded to the independent application program.

In one aspect of the invention, the displaying step can include the steps of displaying a multiplicity of toggleable calendar dates in a multi-month format in a graphical calendar display; and, responsive to receiving a single-month view signal, displaying only those toggleable calendar dates in a single month in a single month format in the graphical calendar display. The toggling step further can include the steps of first toggling a first end-point calendar date from a de-selected state to a selected state; second toggling a second end-point calendar date from a de-selected state to a selected state; automatically setting each state associated with calendar dates in between the first and second end points to a selected state; and, finally toggling at least one calendar date in between the first and second end points to a de-selected state.

### BRIEF DESCRIPTION OF THE DRAWINGS

There are shown in the drawings embodiments which are presently preferred, it being understood, however, that the invention is not limited to the precise arrangements and instrumentalities shown, wherein:

FIGS. 1A and 1B, taken together, are a pictorial illustration of the activation and use of the calendar control component of the present invention;

FIGS. 2A and 2B, taken together, are a pictorial illustration of a process for selecting a non-contiguous set of calendar dates in the calendar control component of the present invention; and, FIG. 3 is block diagram illustrating the interaction between the calendar control of the present invention, an associated computer application and an end user.

### DETAILED DESCRIPTION OF THE PREFERRED EMBODIMENTS

The present invention is a calendar control with which a set of non-contiguous calendar dates can be selected for use in a GUI of an associated computer application. In accordance with the inventive arrangements, a calendar control can provide a graphical set of dates arranged in a calendar format, in which each date can be selected or de-selected as part of a set of non-contiguous calendar dates. Importantly, unlike prior art calendar displays, the calendar control of the present invention can be included in a GUI of a computer application as a stand-alone GUI control. Once the calendar control has been associated with the computer application, an end user can interact with the calendar control to produce a set of calendar dates, regardless of the display position of each selected date in the calendar control.

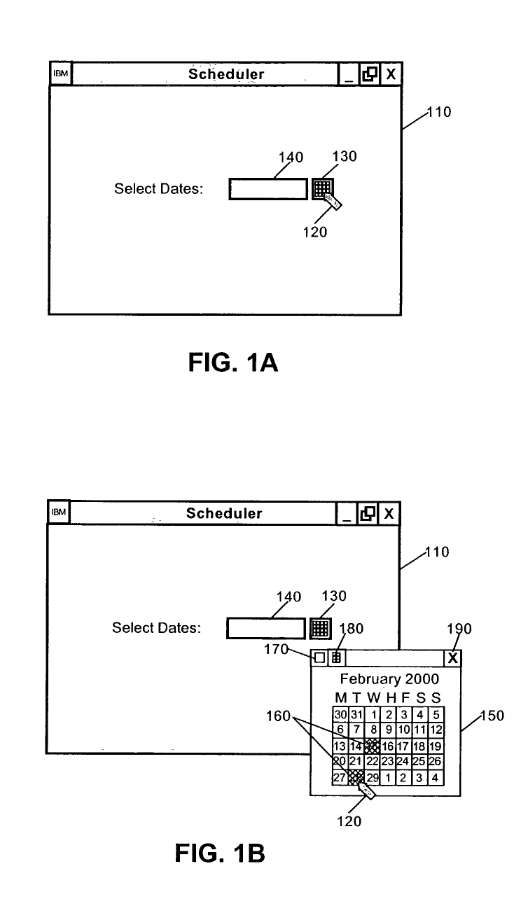

FIGS. 1A and 1B, taken together, are a pictorial illustration of the activation and use of the calendar control component of the present invention. Specifically, the GUI of a computer application 110 can be associated with a calendar control 150 through the activation of a GUI interface element such as a menu entry (not shown), or button 130. Upon activation, for instance using a pointing device 120, the calendar control 150 can be displayed with a pictorial representation of a calendar month. Using the pointing device 120, an end user can select individual calendar dates 160 as illustrated with particularity in FIG. 1B.

Significantly, as will be apparent to one skilled in the art, unlike prior art calendaring tools, in the calendar control 150 of the present invention, the selected calendar dates 160 need not be dates which have been positioned contiguously within the display. Any number of calendar dates can be selected in the calendar control 150 merely by toggling the state of each date in the calendar. Thus, the calendar control 150 can provide an element of date selection flexibility which, heretofore, had been sorely lacking in the prior art.

In one aspect of the present invention, view controls 170, 180 can be positioned in association with the calendar control 150. Specifically, a single month view control 170, upon activation can cause the display only of a single calendar month as substantially shown in FIG. 1B. Conversely, a multi-month control 180, upon activation can cause the display of multiple months (not shown) such as a three-month view or a twelve-month view.

In any case, the end user can toggle individual calendar dates in the calendar control 150. When the end user has completed the selection of a set of calendar dates, such as the selected dates 160, the end user can dismiss the display of the calendar control 150 by selecting the close control 190 using the pointing device 120, for example. Once the end user has selected the close control 190, the calendar control 150 can identify the selected dates and can store the set of selected dates for use by the associated computer application 110. For example, the set of selected dates can be formatted for insertion in an edit box control 140.

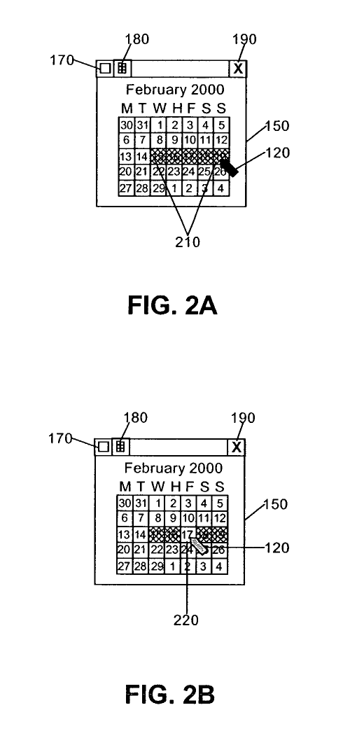

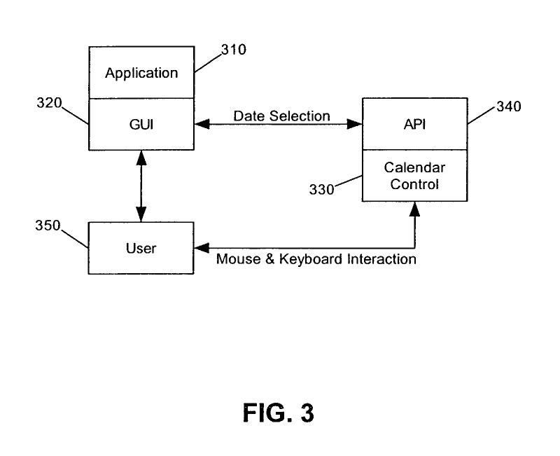

FIGS. 2A and 2B, taken together, are a pictorial illustration of a process for selecting a non-contiguous set of calendar dates in the calendar control component of the present invention. Specifically, a complex set of dates can be selected first by choosing a range of calendar dates 210 with the pointing device 210, and subsequently by deselecting one or more calendar dates 220 within the selected range 210. Though many methods of selecting ranges of contiguously positioned dates are well-known in the art, in accordance with a preferred aspect of the present invention, the range of dates can be selected first by selecting one end-point of the date range. Subsequently, while depressing a pre-configured keyboard key such as the shift key, the other endpoint of the date range can be selected, resulting in the selection of the each calendar date included between both end-points.

FIG. 3 is block diagram illustrating the interaction between the calendar control of the present invention, an associated computer application and an end user. Specifically, a computer application 310 having a GUI 320 can be associated with the calendar control 330 of the present invention using known association techniques in the art. For example, in an object-oriented system, the calendar control 330 can be a class which can be instantiated by the associated application 310. Alternatively, a calendar control factory can create instances of the calendar control 330 for use by requesting applications 320. In any case, the application 310 can access both methods and data members of the calendar control 330 through a control application programming interface (API) 340.

Once the calendar control 330 has been displayed in association with the GUI 320, end users 350 can interact with the calendar control 330 as if the calendar control 330 had been tightly integrated within the source code of the application 310. For instance, the end user 350, using a computer-human interface such as a keyboard and mouse, can select and deselect individual ones or multiple ones of the dates in the calendar display. Furthermore, the end user can select a range of dates, or portions of a range of dates as discussed previously in reference to FIGS. 2A and 2B.

In any event, once the end user 350 has completed the selection of dates, the end user 350 can dismiss the display of the calendar control 330 causing the calendar control 330 to identify the selected dates and to store the set of selected dates in memory. Though the invention is not so limited, the application can access the stored set of selected dates for use in the GUI 320 through the API 340. Alternatively, the calendar control 330 can forward the set of selected dates directly to the GUI 320 upon dismissal of the display of the calendar control 330.

In either case, a set of non-contiguously positioned dates can be selected with an unprecedented ease of use not previously possible using known calendar displays. Moreover, inasmuch as the calendar control 330 of the present invention is an independent GUI control, the calendar control 330 can be re-used with any application which has been configured to incorporate external GUI controls in the GUI of the application.

The present invention can be realized in hardware, software, or a combination of hardware and software. An implementation of the calendar control of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

We claim:

1. A calendar control article of manufacture comprising:
a plurality of graphically toggleable calendar dates, each said toggleable calendar date comprising a state selected from the group consisting of selected and de-selected, each said toggleable calendar date comprising one of said selected and de-selected states independently of the states of contiguous ones of said calendar dates; and,
an application programming interface through which external application programs can access said calendar date states.

2. The calendar control article of manufacture of claim 1, wherein said graphically toggleable calendar dates are arranged in a graphical display of a single calendar month.

3. The calendar control article of manufacture of claim 1, wherein said graphically toggleable calendar dates are arranged in a graphical display of a range of months.

4. The calendar control article of manufacture of claim 3, further comprising a multi-month display control which upon activation can arrange said graphically toggleable calendar dates in a graphical display of a range of months.

5. A method of resolving a set of calendar dates comprising the steps of:
responsive to receiving an activating signal from an independent application program, displaying a plurality of toggleable calendar dates in a graphical calendar display;
visually toggling within said graphical calendar display selected ones of said calendar dates between a selected state and a de-selected state without regard to the state of contiguous ones of said calendar dates;
identifying all of said calendar dates having a selected state; and,
forwarding said identified calendar dates to said independent application program.

6. The method of claim 5, wherein said displaying step comprises the steps of:
displaying a plurality of toggleable calendar dates in a multi-month format in a graphical calendar display; and,
responsive to receiving a single-month view signal, displaying only those toggleable calendar dates in a single month in a single month format in said graphical calendar display.

7. The method of claim 5, wherein said toggling step further comprises the steps of:
first toggling a first end-point calendar date from a de-selected state to a selected state;
second toggling a second end-point calendar date from a de-selected state to a selected state;
automatically setting each state associated with calendar dates in between said first and second end points to a selected state; and,
finally toggling at least one calendar date in between said first and second end points to a de-selected state.

8. A machine readable storage having stored thereon a computer program for resolving a set of calendar dates, said computer program comprising a routine set of instructions for causing the machine to perform the steps of:
responsive to receiving an activating signal from an independent application program, displaying a plurality of toggleable calendar dates in a graphical calendar display;
visually toggling within said graphical calendar display selected ones of said calendar dates between a selected state and a de-selected state without regard to the state of contiguous ones of said calendar dates;
identifying all of said calendar dates having a selected state; and,
forwarding said identified calendar dates to said independent application program.

9. The machine readable storage of claim 8, wherein said displaying step comprises the steps of:
displaying a plurality of toggleable calendar dates in a multi-month format in a graphical calendar display; and,
responsive to receiving a single-month view signal, displaying only those toggleable calendar dates in a single month in a single month format in said graphical calendar display.

10. The machine readable storage of claim 8, wherein said toggling step further comprises the steps of:
first toggling a first end-point calendar date from a de-selected state to a selected state;
second toggling a second end-point calendar date from a de-selected state to a selected state;
automatically setting each state associated with calendar dates in between said first and second end points to a selected state; and,
finally toggling at least one calendar date in between said first and second end points to a de-selected state.
